(19) United States
(12) Patent Application Publication
(10) Pub. No.: US 2024/0356764 A1
(43) Pub. Date: Oct. 24, 2024

(54) Method for Assigning a Digital Model to a Physical Component of an Automation System, Automation System, and Manufacturing Facility

(71) Applicant: Siemens Aktiengesellschaft, München (DE)

(72) Inventors: Rainer Falk, Erding (DE); Kai Fischer, Baldham (DE); Steffen Fries, Baldham (DE); Markus Heintel, München (DE); Wolfgang Klasen, Ottobrunn (DE); Aliza Maftun, München (DE)

(73) Assignee: Siemens Aktiengesellschaft, München (DE)

(21) Appl. No.: 18/686,102

(22) PCT Filed: Aug. 22, 2022
(86) PCT No.: PCT/EP2022/073299

§ 371 Date: Feb. 24, 2024

(30) Foreign Application Priority Data
Aug. 24, 2021 (EP) 21192862.7

(51) Int. Cl. H04L 9/32

(52) U.S. Cl. CPC H04L 9/3268; H04L 9/3297

(57) ABSTRACT

Various embodiments of the teachings herein include a method for assigning a digital model to a physical component of an automation system. An example method includes: consulting a physical component with a piece of link information referring to a digital model of the physical component in a digital twin of the physical component; and using the link information to determine the digital model to which the link information refers and assign said digital model to the physical component.

### CROSS-REFERENCE TO RELATED APPLICATIONS

This application is a U.S. National Stage Application of International Application No. PCT/EP2022/073299 filed Aug. 22, 2022, which designates the United States of America, and claims priority to EP Application No. 21192862.7 filed Aug. 24, 2021, the contents of which are hereby incorporated by reference in their entirety.

### TECHNICAL FIELD

The present disclosure relates to automation. Various embodiments of the teachings herein include methods and/or systems for assigning a digital model to a physical component of an automation system, automation systems, and/or manufacturing facilities.

### BACKGROUND

Digital models form a virtual digital replica of a real object, in particular a device, a machine, or a facility. Such digital models are also referred to as a digital twin. A digital twin may also be realized as part of an administration shell (asset administration shell). The digital twin is typically realized on a data processing facility and can be reached at an address, in particular an IP address and/or a DNS name and/or a URL, via a communication network.

Digital twins process sensitive data relating to the respective associated real object, the integrity and confidentiality of which data need to be ensured. It is therefore necessary to prevent incorrect data or data relating to an incorrect digital twin from being used. Moreover, it is necessary to prevent sensitive data from being provided to an incorrect digital twin. Access to data relating to a digital twin regularly requires an access authentication that involves sensitive access data, in particular a password or an access token, for instance a JSON token or an SAML token, being used or transmitted.

It is therefore necessary to ensure that access to a digital twin associated with a real physical object or with a group of related real objects actually involves a digital twin that is associated with the specific real object in a trusted manner being accessed. In principle, digital twins could be permanently assigned to real physical objects manually. However, such manual, permanent assignment does not scale for a larger number of real objects and is susceptible to error.

### SUMMARY

The teachings of the present disclosure include improved methods for assigning a digital model in the form of a digital twin to a physical component of an automation system that in particular easily scales with the increase in physical components of the automation system and that is in particular easily automatable. For example, some embodiments include a method for assigning a digital model to a physical component of an automation system (AUT), in which a physical component (RO) with a piece of link information (TADTAP), which refers to at least one digital model (DT) of the physical component in the form of a digital twin of the physical component, is consulted (HERA) and in which the link information (TADTAP) is used to determine (ERM) the digital model (DT) to which the link information (TADTA) refers and to assign (ZUG) said digital model to the physical component (RO).

In some embodiments, the link information (TADTAP) includes an optically readable code, in particular a barcode or a QR code.

In some embodiments, the link information is cryptographically protected, in particular by means of a cryptographic check value, e.g. a digital signature or a message authentication code, and is verifiable by means of a cryptographic device key or device certificate associated with the physical component.

In some embodiments, the link information (TADTAP) comprises a contactlessly readable data carrier, in particular an active or passive radio chip, preferably an NFC label and/or an NFC token.

In some embodiments, the link information (TADTAP) comprises a URL and/or a link, for instance a piece of reference information, in particular a name, in a directory (TDTD) of digital models.

In some embodiments, the link information (TADTAP) comprises information about a category of data relating to the digital model (DT) and/or another property of data relating to the digital model, in particular a currentness and/or a transfer protection and/or an accuracy of the data.

In some embodiments, the physical component (RO) checks properties of the digital model (DT) and/or of data processed by the digital model (DT) for consistency with predefined properties.

In some embodiments, the link information (TADTAP) is valid for a limited time.

In some embodiments, the link information (TADTAP) refers to two or more digital models (TT) of the physical component (RO).

As another example, some embodiments include an automation system including at least one physical component (RO) and an interface to at least one digital model (DT) of the physical component (RO), wherein the physical component (RO) includes at least one piece of link information (TADTAP) that refers to the at least one digital model (DT) of the physical component (RO).

As another example, some embodiments include an automation system designed to perform one or more of the methods described herein.

In some embodiments, the automation system has at least two physical components (RO1, RO2) that each comprise a piece of link information (ADT-Att1, ADT-Att2), wherein the two pieces of link information (ADT-Att1, ADT-Att2) refer to the same digital model (DT).

In some embodiments, the automation system includes a network (NET), in particular an Internet of Things network, and/or which is part of a manufacturing facility.

As another example, some embodiments include a manufacturing facility including an automation system (AUT) as described herein.

### BRIEF DESCRIPTION OF THE DRAWINGS

The teachings herein are explained in more detail below on the basis of an exemplary embodiment depicted in the drawings, in which:

FIG. 1 schematically shows a block diagram of a sequence of an exemplary embodiment of a method incorporating teachings of the present disclosure to determine a trusted digital twin;

FIG. 2 schematically shows a basic diagram of an automation system incorporating teachings of the present disclosure with a physical component and with a digital twin during performance of the method to determine a trusted digital twin as shown in FIG. 1;

FIG. 3 schematically shows a basic diagram of a further exemplary embodiment of an automation system incorporating teachings of the present disclosure with a physical component and with a digital twin during performance of the method to determine a trusted digital twin as shown in FIG. 1; and

FIG. 4 schematically shows a basic diagram of an application for the exemplary embodiments as shown in FIGS. 2 and 3.

### DETAILED DESCRIPTION

Some embodiments of the teachings herein include a method for assigning a digital model to a physical component of an automation system involves a physical component with a piece of link information, which refers to at least one digital model, being consulted and the link information being used to determine the digital model to which the link information refers and to assign said digital model to the physical component. In some embodiments, the link information is physically integrated in or on the physical component and, in particular exclusively, accessible in, in particular direct, contact with the physical component and/or at a maximum spatial distance from the physical component.

The method can thus involve the link information of the physical component being consulted. As a result, access to the physical component is necessary in order to change the link information that refers to the digital model. In this way, a physical component with a piece of link information results in the assignment of a digital model to the physical component being particularly reliable, because a change to the link information of the physical component is possible unintentionally or with the intention of an attack remotely only with difficulty. The link information provided therefore forms a physical accreditation of a link to the digital model to a certain extent. The link information of the physical component therefore anchors the digital model to the physical component in the physical world. In some embodiments, the link information in the case of the method according to the invention is a piece of physical link information that can be read optically or inductively or by radio. In particular, the link information is realized on a hardware basis, that is to say in particular not as computer-implemented variable software.

The digital model for the purposes of the present disclosure is a virtual digital replica of the physical component of the automation system, i.e. a digital representative of the physical component in particular in the form of a digital twin. The digital twin may also be realized as an administration shell (asset administration shell). In some embodiments, the digital model includes a digital simulation of the physical component. The digital twin may be realized on a data processing facility and reachable at an address, in particular an IP address and/or a DNS name and/or a URL, via a communication network.

In some embodiments, the link information is cryptographically protected, in particular by means of a cryptographic check value, e.g. a digital signature or a message authentication code. The link information may be verifiable in particular by means of a cryptographic component key or component certificate associated with the physical component. In this way, manipulation of the link information can additionally be effectively prevented. The component key or the component certificate is expediently readable or queryable directly from the physical component or is provided by a manufacturer or operator of the physical component.

In some embodiments, the link information includes an optically readable code, in particular a barcode or a QR code. In this way, the link information may be easily optically readable, in particular by means of a barcode reader or a QR code reader, expediently by means of a barcode reader app or a QR code reader app on a smartphone or a tablet and/or a mobile computer.

In some embodiments, the link information comprises a contactlessly readable data carrier, in particular at least one active or passive radio chip, e.g. an NFC label and/or an NFC token. Using a contactlessly readable data carrier requires the digital model to be assigned to the physical component in spatial proximity, i.e. at a maximum distance from the physical component, similarly to in the case of an optically readable code. An inadmissible change to (manipulation of) the link information remotely, i.e. at a greater distance than the maximum distance, from the physical component, for instance via the Internet or by a spatially remote attacker, is not possible in this development of the invention. Using a contactlessly readable data carrier, in particular using an active or passive radio chip, allows the digital model to be assigned to the physical component in spatial proximity to the physical component by means of a digital reader of the contactlessly readable data carrier in an automated manner, however. A level of manual effort for assigning the digital model to the physical component can therefore be kept extremely low in this development.

In some embodiments, the link information comprises an address, in particular a URL, and/or a link, for instance a piece of reference information, in particular a name, in a directory of digital models. Using the name or using the link therefore allows the digital model to be easily found. Using the URL or using the link, for instance using the reference information, allows the digital model to be located, e.g. definitely, and assigned to the physical component.

In some embodiments, the link information comprises information about a category of data relating to the digital model and/or another property of data relating to the digital model, in particular a currentness and/or a transfer protection and/or an accuracy of the data. As such, the link information may contain information about how current the data relating to the digital model are, or with what security the data relating to the digital model are protected or need to be protected. Furthermore, an accuracy of the data may also be included, in particular an accuracy of location data or else an accuracy of the association of the data with persons, operators or devices, for instance whether the data are associated with individual persons or with groups of persons or with an individual operator or with groups of operators or with an individual device or with groups of devices or with pseudonyms, or are not associated at all, i.e. are anonymous.

In some embodiments, the physical component checks properties of the digital model and/or of data processed and provided by the digital model for consistency with predefined properties. In this way, the physical component can ascertain whether properties of the digital model are still consistent with the actual properties of the physical component. In the event of a variance, the physical component can remove the assignment of the digital model to this physical component. By way of example, the link information can be updated, with the result that it is possible to ascertain that there is no further provision for the digital model to be assigned to the physical component. If an assignment of a digital model is removed from a physical component, the physical component can cancel the link information.

In some embodiments, the link information is valid for a limited time. In this way, the assignment of the digital model to the physical component must be made again after a validity of the link information has ended. In this development, it is therefore not necessary to cancel an assignment of the digital model to the physical component if security-critical changes to the digital model, for instance attacks on the digital model by a third party, arise, but rather this development requires current link information of the physical component for a digital model to be followed in order to remake an assignment.

In some embodiments, the link information refers to two or more digital models of the physical component. There may therefore be digital models for the physical component on a redundant basis, resulting for instance in a particularly high level of security with respect to unintentional changes to the digital model. Attacks on the digital model can also be easily detected in this development, because undetected attacks would need to successfully occur on the two or more digital models in sync. Furthermore, availability can be improved if there are multiple digital models.

The automation systems incorporating teachings of the present disclosure are designed to perform one or more of the methods as described herein. An example automation system includes at least one physical component, wherein the physical component includes at least one piece of link information that refers to at least one digital model of the physical component. In some embodiments, the automation system is designed to perform a method as described earlier. In some embodiments, the physical component includes an interface to the digital model of the physical component.

In some embodiments, the automation system has at least two physical components that each comprise a piece of link information, wherein the two pieces of link information refer to the same digital model. In this development, one and the same digital model may be assigned to two physical components. By way of example, the two physical components may be provided on a redundant basis for security reasons or for availability reasons or for reasons of functional safety.

In some embodiments, the automation system is a network, in particular an Internet of Things network, or the automation system includes such a network, in particular an Internet of Things network. In some embodiments, the automation system is part of a manufacturing facility. A manufacturing facility incorporating teachings of the present disclosure includes such an automation system.

The methods and systems incorporating teachings of the present disclosure may involve the physical component being configured and designed to check properties of the digital model and/or of data processed and provided by the digital model for consistency with predefined properties or data of the physical component. In this way, the physical component can ascertain whether properties of the digital model are still consistent with the actual properties of the physical component. In the event of a variance, the physical component can remove the assignment of the digital model to this physical component. In particular, the link information can be updated, with the result that it is possible to ascertain that there is no further provision for the digital model to be assigned to the physical component.

Furthermore, the teachings herein allow the link information to contain information indicating whether the physical component carries out such a check, and, if so, when this last took place and/or what properties were checked for consistency. Furthermore, the link information can contain information from digital models for which the assignment was removed. This may be useful if a user has stored the connection of a physical component to a digital model in order to prevent an invalid digital model from being accessed.

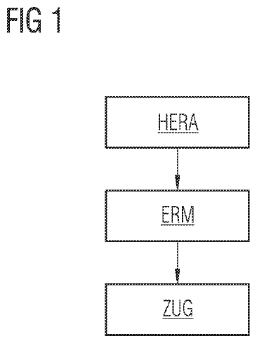

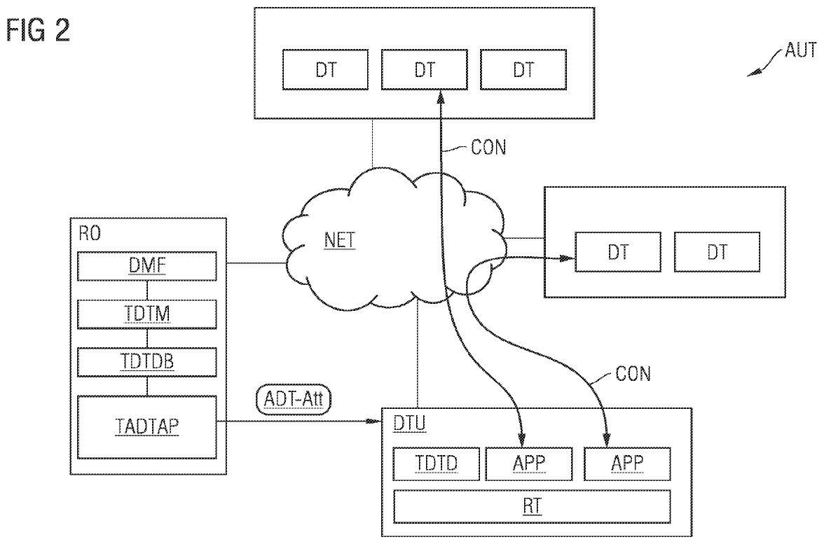

The method incorporating teachings of the present disclosure depicted in FIG. 1 involves a digital model being determined for a physical component of an automation system AUT. This initially involves a first step HERA comprising consulting a physical component, in the form of a real industrial device RO (see FIG. 2), that refers to at least one digital model in the form of a digital twin DT (FIG. 2). The physical component uses link information to refer to the digital model. Using the link information, a determination step ERM comprises determining the digital model and assigning it to the physical component in an assignment step ZUG. The method according to the invention and the automation system AUT according to the invention are also explained in more detail below with reference to FIGS. 2 to 4:

The automation system AUT incorporating teachings of the present disclosure depicted in FIG. 2 comprises a network NET and a real industrial device RO, which is linked to the network NET, for which a trusted digital twin is determined by a method incorporating teachings of the present disclosure. The automation system AUT in the exemplary embodiment depicted is a manufacturing system and the real industrial device RO is a physical component, for example in the form of a manufacturing tool. In principle, in other exemplary embodiments, not depicted specifically, the automation system AUT may also be a further automation system, for example a process control system for a process engineering facility, for example a biotechnological facility, the real industrial device RO being able to be a process monitor for the biotechnological facility or a valve or a transport container.

The digital twin in the exemplary embodiment depicted forms a digital model of the industrial device RO that accepts data relating to the industrial environment to which the industrial device RO is exposed: in the exemplary embodiment depicted, control commands relating to the industrial device and environmental parameters, for instance an ambient temperature, relating to the industrial device RO. Moreover, the digital model of the industrial device RO outputs a digital representation of the workpiece manufactured by the industrial device RO. The digital twin thus processes control commands and environmental parameters to produce a digital model of the workpiece manufactured using the real industrial device RO.

Moreover, there are other digital twins of the industrial device RO that, although they receive identical input data as described above, provide different output data, for example output data in the form of a predicted cost-optimized maintenance time for the real industrial device RO. Furthermore, there are other digital twins of the real industrial device RO that provide efficient configuration and/or production-speed-optimized device management and/or diagnosis of the real industrial device RO as output data.

In the exemplary embodiment depicted, the real industrial device RO provides trusted identification information TADTAP relating to one or more digital twins DT. This trusted identification information TADTAP is consulted in a step HERA of the method according to the invention for assigning the digital twin DT. The identification information TADTAP gets its trusted nature from the origin of the identification information from the real industrial device RO itself: the identification information is provided by a hardware of the industrial device RO. The hardware is therefore used to provide a hardware-based accreditation ADT-Att for the identification information TADTAP of the respective digital twin DT. The accreditation ADT-Att of the identification information TADTAP of the respective digital twin DT is also referred to simply as accreditation ADT-Att for short below. The accreditation ADT-Att also contains the identification information TADTAP of the respective digital twin DT assigned to the real industrial device RO. By way of example, the identification information TADTAP of the respective digital twin DT may include a URL and/or a checksum, for instance a hash value, and/or a digital fingerprint of a public key or of a digital certificate of the digital twin DT.

The accreditation ADT-Att additionally includes at least one piece of identification information relating to the real industrial device RO providing the accreditation. The identification information of the real industrial device RO may likewise be formed by means of a checksum, for example a hash value, and/or a digital fingerprint of a public key or a digital certificate or a verifiable credential of the real industrial device RO.

In the exemplary embodiment depicted, the identification information TADTAP of the respective digital twin DT contains an address for establishing a connection to the assigned digital twin, for instance a URL as described earlier. Alternatively, the identification information TADTAP can provide a link that can be used to find the respective digital twin DT, for example a piece of reference information about a symbolic name in a directory of digital twins.

The accreditation ADT-Att can be formed using a security element (secure element) of a trusted execution environment or a crypto chip or integrated crypto circuit of the object. In particular, the information contained in the security element and confirmed using the accreditation ADT-Att can be securely stored and managed in a manner protected against manipulation. This allows the trusted nature and integrity of the accreditation ADT-Att to be ensured.

The accreditation ADT-Att in the exemplary embodiment depicted contains identification information from a or for multiple digital twins assigned to the industrial device RO. In other exemplary embodiments, not depicted specifically, the accreditation ADT-Att additionally contains a statement relating to a respective purpose for the use of the respective digital twin, for example a purpose in the form of simulation and/or configuration/or device management and/or diagnosis of the real industrial device RO and/or predictive maintenance of the real industrial device RO. This statement relating to the purpose confirms that the respective digital twin is intended to be trusted for realizing the specified purpose. In a variant, the statement can distinguish between different data elements, for example data paths, of the digital twin.

The real industrial device RO can take license information as a basis for providing different scopes of data relating to the real industrial device RO to a respective digital twin DT assigned to the real industrial device RO, or the data of the real industrial device RO are provided to the respective assigned digital twin DT with varying frequency or with varying protection. The accreditation ADT-Att can contain information regarding which of the data of the real industrial device RO are available in the respective assigned digital twin DT and contain a quality statement indicating for instance the frequency of update and/or a protection for the transfer of the provided data. Moreover, the accreditation ADT-Att can contain information about whether the data provided by the real industrial device RO are in some cases replicated in the respective digital twin DT only after preprocessing, in particular anonymization or pseudonymization and/or filtering and/or noise addition.

The accreditation ADT-Att may moreover contain a temporal validity statement for assigning the digital twin.

The accreditation ADT-Att is arranged on the real industrial device RO itself and is readable, for example by way of RS232 and/or SPI and/or I2C and/or USB and/or optically, using a code that can be displayed in a display of the device, and cryptographically protected. By way of example, there is a readable code that contains for instance an alphanumeric code, a barcode or a QR code. The readable code may be cryptographically protected, for instance by a cryptographic key or a cryptographic check value, for example a checksum. In some embodiments, the accreditation may be formed using a component, for instance an NFC label and/or an NFC token, that is permanently connected to the real industrial device RO and provides a content of the accreditation ADT-Att, which content is cryptographically protected by a cryptographic check value, for example a checksum.

The cryptographic check value may be a digital signature or a message authentication code. It may in particular be computable by way of a secret, i.e. private, device key of the real industrial device RO, and verifiable by way of a device certificate associated with the real industrial device RO. The accreditation can be provided on demand or transmitted repeatedly as a broadcast message. The accreditation can also be transferred via a network interface, e.g. Ethernet or WLAN, or a 5G mobile radio interface or a Bluetooth interface and for example provided within local limits, that is to say provided only to receivers that are not beyond a maximum distance from the real industrial device RO. Such locally limited provision may be realized for instance by means of a non-routable IP address or by means of a radio signal with limited transmission power.

The real industrial device RO can check properties of the digital twin DT and/or of data processed and provided by the digital twin DT for consistency with predefined properties or data of the real industrial device RO. In this way, the real industrial device RO can ascertain whether properties of the digital twin DT are still consistent with the actual properties of the real industrial device RO. In the event of a variance, the real industrial device RO can remove the assignment of the digital model DT to this real industrial device RO. By way of example, the identification information TADTAP can be updated, with the result that it is possible to ascertain that there is no further provision for the digital twin DT to be assigned to the real industrial device RO. Furthermore, it is possible for the accreditation ADT-Att to contain information indicating whether the real industrial device RO carries out such a check, and, if so, when this last took place and/or what properties were checked for consistency. Furthermore, the accreditation ADT-Att can contain identification information TADTAP from digital twins DT for which the assignment was removed. This may be useful if a user DTU has stored the connection of a real industrial device RO to a digital twin DT in order to prevent an invalid digital twin from being accessed.

In the exemplary embodiment depicted, the real industrial device RO provides an accreditation ADT-Att to a user DTU. The industrial device TDTDB maintains a database TDTDB of trusted digital twins DT. The digital twins DT held in this database TDTDB are marked by means of the identification information TADTAP of the accreditation ADT-Att uniquely and so as to be able to be found by the user DTU. The database TDTDB of trusted digital twins DT is managed by a management service TDTM in the real industrial device RO and occasionally updated, for example via a configuration interface of the real industrial device RO, which is not shown explicitly. The primary function DMF of the real industrial device RO is for example an open- or closed-loop control functionality of the real industrial device RO, which is a manufacturing tool.

The user DTU wishing to use a digital twin DT of the real industrial device RO uses a selection tool TDTD to select a trusted digital twin DT from the database TDTDB in a determination step ERM of the method according to the invention on the basis of the accreditation ADT-Att provided by the real industrial device RO, after verifying the cryptographic protection of the accreditation ADT-Att. With the selected digital twin DT, the user DTU makes a communication connection CON to the digital twin DT via the network NET on the basis of a URL of the digital twin DT, contained in the accreditation ADT-Att. The user DTU therefore uses the communication connection to assign the digital twin DT in an assignment step ZUG of the method according to the invention. In the example depicted, the user DTU has provision for two apps APP executed in an execution environment RT, in order to use digital twins DT. Here, the selection of a suitable digital twin DT, depending on a purpose assigned to the respective app APP, e.g. predictive maintenance and/or simulation, can involve a digital twin DT provided for this purpose being automatically selected from the plurality of provided digital twins DT of the real industrial device RO, and the respective app APP can be provided with appropriate information.

If multiple real industrial devices RO are assigned to a single digital twin DT, the accessing user DTU can receive different authorizations, depending on the purpose, that allow either access to data of a specific real industrial device RO assigned to the digital twin DT or else access to data of all real industrial devices RO assigned to the digital twin DT. The latter case facilitates for example comparison of the data from real industrial devices RO of the same type and can be used to carry out a plausibility check between different instances of the real industrial devices RO. This can be used e.g. for monitoring a real industrial device RO or else for comparing redundant real industrial devices RO, for example for a hot standby. It is likewise possible for data of multiple real industrial devices RO to be combined within the context of a manufacturing step of the automation system AUT.

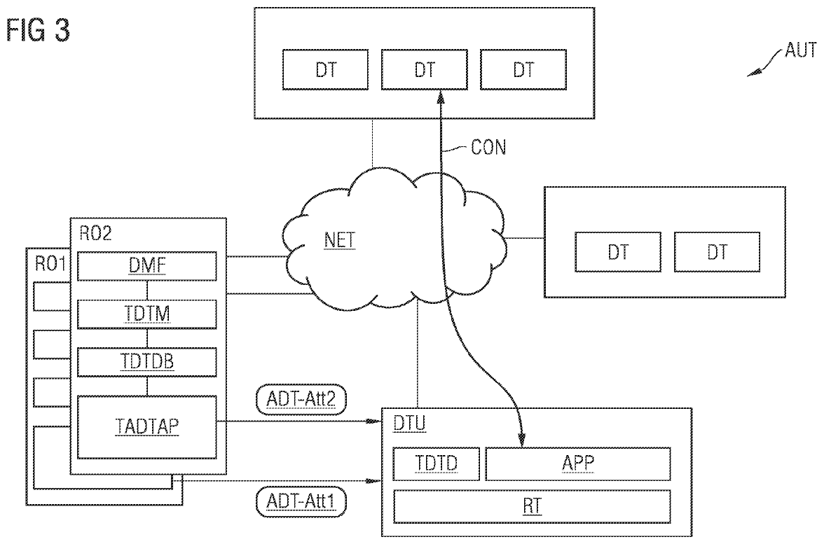

FIG. 3 shows two real industrial devices RO1, RO2 assigned to just one digital twin DT. As in the exemplary embodiment described with reference to FIGS. 1 and 2, the real industrial devices RO1, RO2 each provide an accreditation ADT-Att1, ADT-Att2. The user DTU accesses the assigned digital twin DT. Depending on the selected accreditations ADT-Att1 or ADT-Att2 or both, the user DTU can configure different authorizations for accessing the data of the digital twin DT.

The accreditations ADT-Att, ADT-Att1, ADT-Att2 may be coded e.g. as an ASN.1 data structure or as XML or as a text document or as a binary file or as a JSON data structure or as an attribute value list or in another way and can contain a content of the accreditation ADT-Att, ADT-Att1, ADT-Att2, cryptographically protected by a cryptographic check value, for example a checksum.

By way of example, the cryptographic check value may be realized by means of a cryptographic one-way function and/or by means of a digital signature and/or by means of a message authentication code.

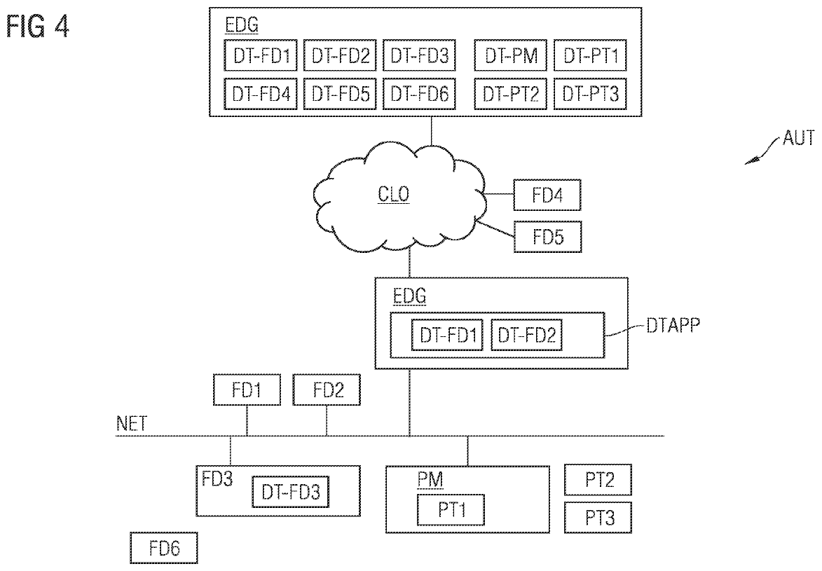

As an application scenario, FIG. 4 shows, by way of illustration, an automation system AUT containing multiple real, physical industrial devices in the form of field devices FD1, FD2, FD3, FD4, FD5, FD6. The field devices FD4, FD5 are connected directly to an open network CLO. The field devices FD1, FD2, FD3, on the other hand, are in a network NET of the automation system AUT, which is connected to the open network CLO via an edge server EDG. The field device FD6 is intended as a substitute device and is not connected to the network NET of the automation system AUT. Furthermore, there is provision for a production machine PM, here a machine tool, by way of illustration a press or a transport system. Furthermore, the automation system AUT includes three production means PT1, PT2, PT3, for example tools, for instance a milling head for a machine tool or a printing head for an additive manufacturing machine in the form of a 3D printer. Furthermore, there is provision for a cloud backend service CBE. The automation system AUT depicted in FIG. 4 forms a manufacturing system incorporating teachings of the present disclosure.

One or more digital twins DT-FD1, DT-FD2, DT-FD3, DT-FD4, DT-FD5, DT-PM, DT-PT1, DT-PT2, DT-PT3 are provided for and assigned to each of the real field devices, i.e. the field devices FD1, FD2, FD3, FD4, FD5, FD6, and the production machine PM and the production means PT1, PT2, PT3 as virtual representations of the respective real field device FD1, FD2, FD3, FD4, FD5, FD6 and the production machine PM and the production means PT1, PT2, PT3. These are realized in the cloud backend CBE in the exemplary embodiment depicted. Moreover, digital twins DT-FD1, DT-FD2 of the field devices FD1, FD2 are realized on the edge server EDG of the automation system AUT, e.g. as a digital twin app DTAPP. Furthermore, the field device FD3 additionally contains an integrated virtual digital twin DT-FD3 in order to be able to carry out simulations.

What is claimed is:

1. A method for assigning a digital model to a physical component of an automation system, the method comprising:
consulting a physical component with a piece of link information referring to a digital model of the physical component in a digital twin of the physical component; and
using the link information to determine the digital model to which the link information refers and assign said digital model to the physical component.

2. The method as claimed in claim 1, wherein the link information includes an optically readable code.

3. The method as claimed in claim 1, wherein the link information is cryptographically protected and is verifiable by a cryptographic device key or device certificate associated with the physical component.

4. The method as claimed claim 4, wherein the link information comprises a contactlessly readable data carrier.

5. The method as claimed in claim 1, wherein the link information comprises a URL and/or a link.

6. The method as claimed in claim 1, wherein the link information comprises information about a category of data relating to the digital model and/or another property of data relating to the digital model.

7. The method as claimed in claim 1, wherein the physical component checks properties of the digital model and/or of data processed by the digital model for consistency with predefined properties.

8. The method as claimed in claim 1, wherein the link information is valid for a limited time.

9. The method as claimed in claim 1, wherein the link information refers to two digital models of the physical component.

10. An automation system including:
a physical component; and
an interface to a digital model of the physical component;
wherein the physical component includes a piece of link information referring to the digital model of the physical component.

11. An automation system according to claim 10, further comprising a controller to:
consult the physical component with a piece of link information referring to the digital model of the physical; and
use the link information to determine the digital model to which the link information refers and assign said digital model to the physical component.

12. The automation system as claimed in claim 10, the system comprising two physical components each with a respective piece of link information;
wherein the two pieces of link information refer to the digital model.

13. The automation system as claimed in claim 10, further comprising a network and/or which is part of a manufacturing facility.

14. (canceled)
